(19) United States
(12) Patent Application Publication
(10) Pub. No.: US 2009/0159192 A1
(43) Pub. Date: Jun. 25, 2009

(54) Method of Manufacturing a Polypropylene Pinch Bag

(76) Inventor: Roger Bannister, Crossett, AR (US)

Correspondence Address: ROY, KIESEL, KEEGAN & DENICOLA, 2355 DRUSILLA LANE, BATON ROUGE, LA, 70509, US

(21) Appl. No.: 11/962,252

(22) Filed: Dec. 21, 2007

(51) Int. Cl. B32B 37/00

(52) U.S. Cl. 156/250

(57) ABSTRACT

An improved belt-clip holder for various objects is disclosed. The holder may be of unitary construction and includes a belt-clip for securely attaching the holder to a user's belt or other suitable item. The unitary construction reduces the cost and complexity of the holder. The holder has front, back and side panels to hold and protect an object, such as a dipping tobacco tin, or a group of objects, such as a group of credit cards. The holder also may have bottom panels in some embodiments. A retainer, having an integral retaining lip, secures the held object or objects in the holder. A cavity formed by the lower edges of the front, back, and side panels, allows a user to push a held object upward in order to remove the object from the holder. The retainer is configured so that a user my disengage the integral retaining lip using the same hand used to push the held object upward via the cavity. In this manner, the holder allows for the secure retention of an object within the holder, and also for easy, single-handed, removal of the object by a user when such removal is desired.

### FIELD OF THE INVENTION

The invention relates to polypropylene bags in general and to high strength polypropylene bags in particular.

### PRIOR ART

Many different types of products are shipped and sold in bags. It is often desirable to make the bags out of a strong plastic such as polypropylene. Polypropylene is largely impervious to water. Thus, if a polypropylene bag is wetted, it can often be returned to a merchantable condition by wiping it off or simply allowing it to dry. Polypropylene is also impenetrable by most oils. Consumer packaged goods can be rendered unmerchantable by oily spots on the exterior of the package caused by seep through from oils in the product. Polypropylene bags are very good at keeping the oils in the product inside the bag and away from any exterior labels or artwork. Tears or rips in bags can also render goods unmerchantable. Additionally, such tears or rips can spill product on the floor of retail and other businesses, creating a potential slip and fall danger. Polypropylene, particularly axially oriented polypropylene, is very strong. Polypropylene bags are thus highly resistant to tears.

However, the features that make polypropylene such good bag material, also make it difficult to form bags from polypropylene, particularly a type of bag known as a gusseted pinch bag. Gusseted pinch bags offer numerous advantages over other bag styles. This closure method has a very low leak rate. Powders and oils cannot seep out of the closure. This can be contrasted with bags that are sewn closed, where there is always some space between the stitching through which liquids and fine powders can escape. Similarly, moisture laden air can reach the product through stitching and other common closure methods. This can lead to some products becoming stale, clumping or otherwise deteriorating. Likewise, insects can enter bags via gaps in stitching. Pinch bag closures substantially eliminate the risk of air, water, and insects reaching the product via the closure. When filled, there is also a delineation between the sides and faces of gusseted bags. This gives the bags a box-like quality that facilitates stacking and that can be advantageous both in shipping and for in-store displays. Gusseted bags are also easy to fill.

Gusseted pinch bags are typically manufactured by perforating a continuous sheet of material into bag shaped panels. Before the perforations are severed but after they are formed, the sheet is folded so that its outside edges overlap and are adhered together. This forms a “tube,” that will comprise a series of bag shaped segments connected by the perforations. Once the tube is formed, longitudinal pressure is applied to the terminal bag shaped segment. This causes the perforations to break, leaving an individual bag shaped segment with two open ends. The bottom end of each segment is closed by folding the end of the bag over and adhering it to itself, thereby creating a bag. These are stacked and sent to the packager, where the bag is filled and the opposite end closed.

Polypropylene presents two significant obstacles to the foregoing process. First, polypropylene's general imperviousness to water and most oils, makes it difficult for adhesives to bind effectively to it. Thus, adhesively sealing a polypropylene pinch bag is difficult. Nor are the standards for an acceptable seal easily met. Bags are often subjected to extreme variations in temperature during transit. Conditions in uninsulated truck and rail cars can vary from below freezing in the winter to well above 100° F. in the summer. Accordingly, industry standards require adhesive seams to maintain their integrity from 0° F. through 140° F. Testing to these standards are commonly referred to as the freeze test and the heat test.

Second, the high strength of axially oriented polypropylene makes it difficult to form workable perforations. When the material is being perforated, it cannot be completely severed. Rather, it must retain its identity as a sheet to allow the sheet to be folded into a tube. If the perforation line suffers even a partial failure prior to the separation of the bag segments, at a minimum, the particular bag is likely to be rendered unusable. More significantly and more commonly, the entire tubing process goes offline, jams have to be cleared, and material and most significantly, time is lost.

Once the tube is formed the terminal bag shaped segment must be removed cleanly. If a single strand of material does not break, the terminal bag remains attached to the tube, and the process jams up. The high linear strength of axially oriented polypropylene makes the creation of a fine enough perforation extremely challenging. If the perforations are too small and too close together, the perforation becomes a complete cut. If the perforations are too far apart, the bag segments will not separate cleanly and consistently. Therefore, a process for manufacturing axially oriented polypropylene gusseted pinch bags in accordance with the following objectives is desired.

### OBJECTS OF THE INVENTION

It is an object of the invention to provide a method for manufacturing axially oriented polypropylene bags.

It is an additional object of the invention to provide a method for manufacturing axially oriented polypropylene pinch bags.

It is an additional object of the invention to provide a method for manufacturing axially oriented polypropylene gusseted pinch bags.

It is another object of the invention to provide a method of manufacturing bags that will be resistant to punctures.

It is yet another object of the invention to avoid or limit loss of product due to bag damage.

It is still another object of the invention to avoid or limit product spills due to bag damage.

### SUMMARY OF THE INVENTION

A method of manufacturing a pinch bag, and preferably a gusseted pinch bag, from polypropylene is disclosed. A sheet of polypropylene is provided. The sheet is preferably comprised of one or more layers of axially and/or biaxially oriented polypropylene. Perforation lines in a pinch pattern are formed in the sheet. The perforation lines are preferably created with a laser that forms a series of small, closely spaced holes in the sheet along the perforation line. The laser heats the plastic surrounding the holes, causing the polypropylene molecules between the holes to lose their orientation. Thus, the polypropylene in the perforation line between the holes is substantially weakened. The sheet is then folded into a tube. The edges of the sheet are sealed together, thereby forming the tube. A lateral force is applied to the terminal tube in the sheet, breaking the perforation line and separating the terminal tube from the sheet. One end of the tube is then sealed, thereby forming a bag.

### BRIEF DESCRIPTION OF THE DRAWINGS

FIG. 1 is a perspective view showing a polypropylene matrix being laminated to a polypropylene sheet.

FIG. 2 is a perspective view of an example of a polypropylene weave.

FIG. 2A is an exploded view illustrating a preferred embodiment of a polypropylene weave being laminated to a polypropylene sheet.

FIG. 3 is a plan view of a preferred embodiment of a single detachable gusseted pinch bag section.

FIG. 3A is a plan view of a preferred embodiment of a single detachable pinch bag section.

FIG. 4 is a plan view of a polypropylene sheet segmented with perforations into a plurality of detachable gusseted pinch bag sections.

FIG. 4A is a close up view of the perforations circled in FIG. 4.

FIG. 4B is a detailed view, including preferred dimensions, of the perforations circled in FIG. 4A.

FIG. 4C is a plan view of a polypropylene sheet segmented with perforations into a plurality of detachable pinch bag sections.

FIG. 5 is a perspective view of a preferred embodiment of a detachable bag section being folded into a gusseted tube.

FIG. 6A is a side view of a preferred embodiment of a gusseted tube.

FIG. 6B is a plan view of a preferred embodiment of a gusseted tube.

FIG. 6C is an end view of a preferred embodiment of a gusseted tube.

FIG. 7A is a perspective view of a preferred embodiment of a gusseted tube being folded closed at one end to form a bag.

FIG. 7B is a perspective view of a preferred embodiment of a bag.

FIG. 8A is a perspective view of a preferred embodiment of a detachable bag section being folded into a gusseted tube wherein the seam includes a vent.

FIG. 8B is a cut-away view of a preferred embodiment of a bag containing a vent.

FIG. 8C is a top view of a preferred embodiment of a bag containing a vent.

FIG. 9 is a perspective view of a dual layer of hot melt adhesive being applied.

FIG. 10 is a schematic illustration of a laser perforation module being used to perforate a polypropylene sheet.

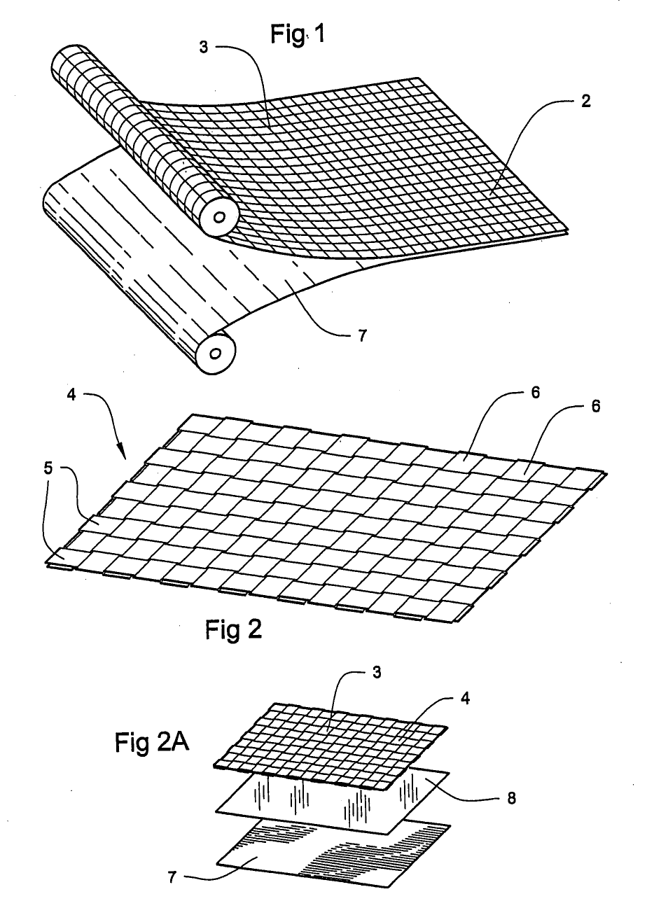

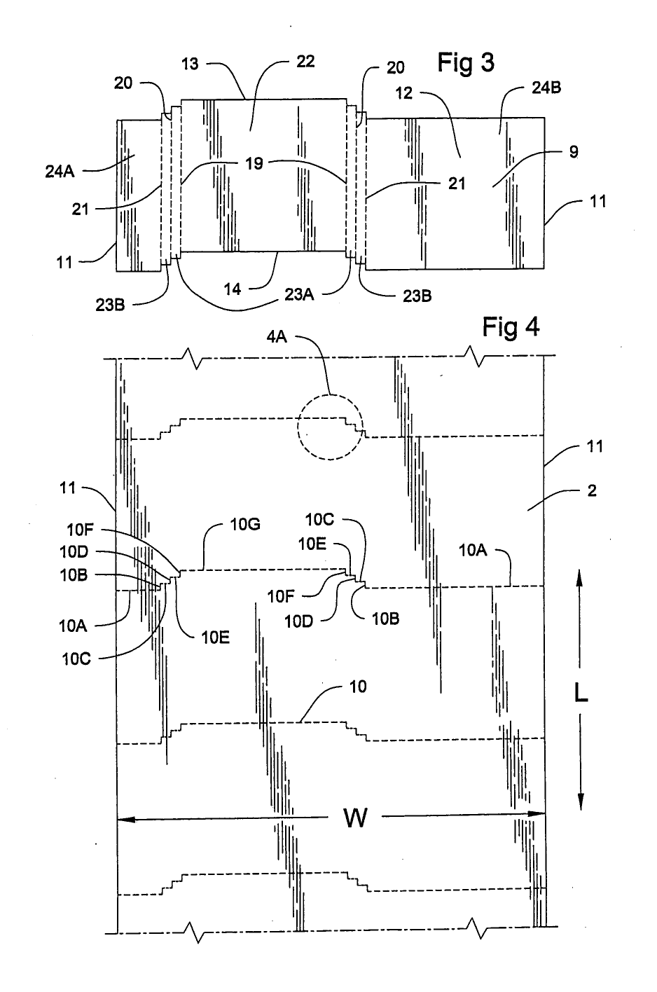

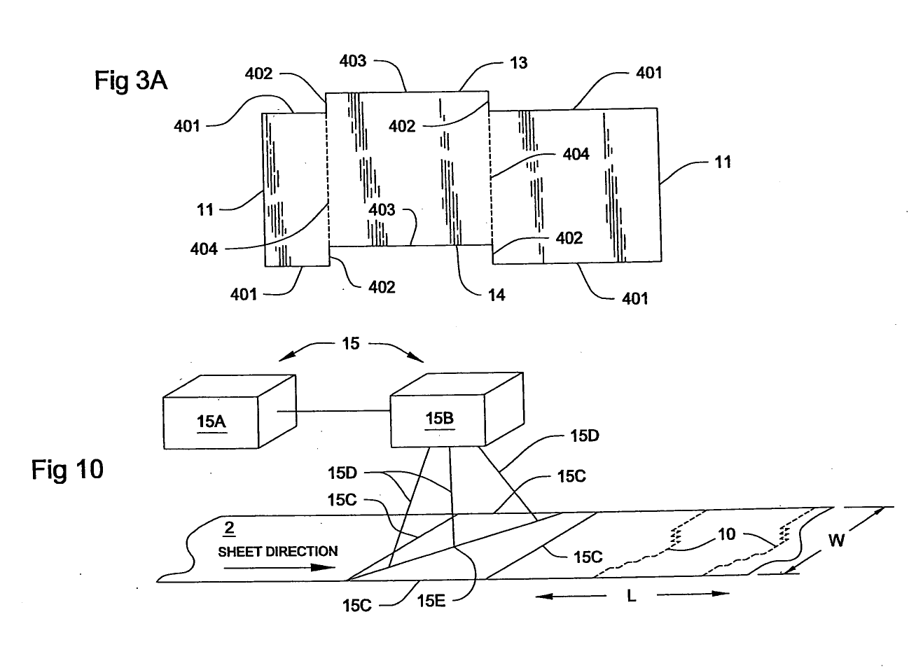

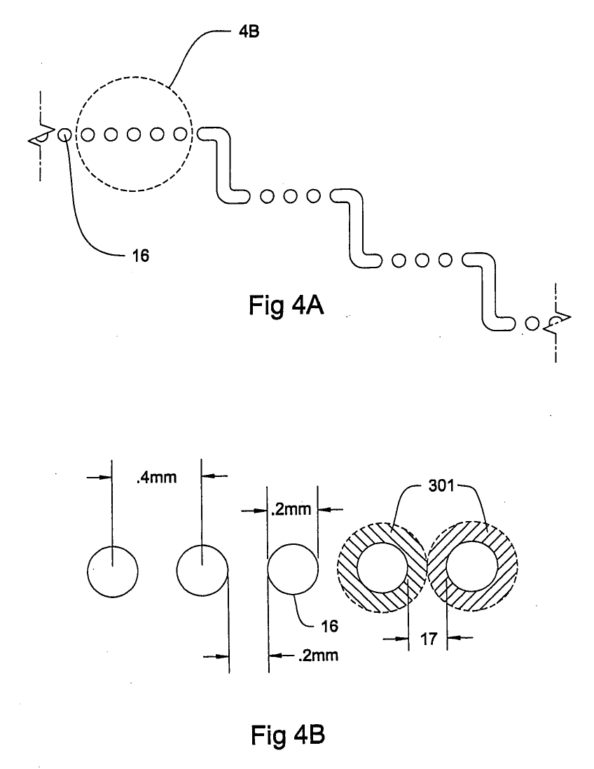

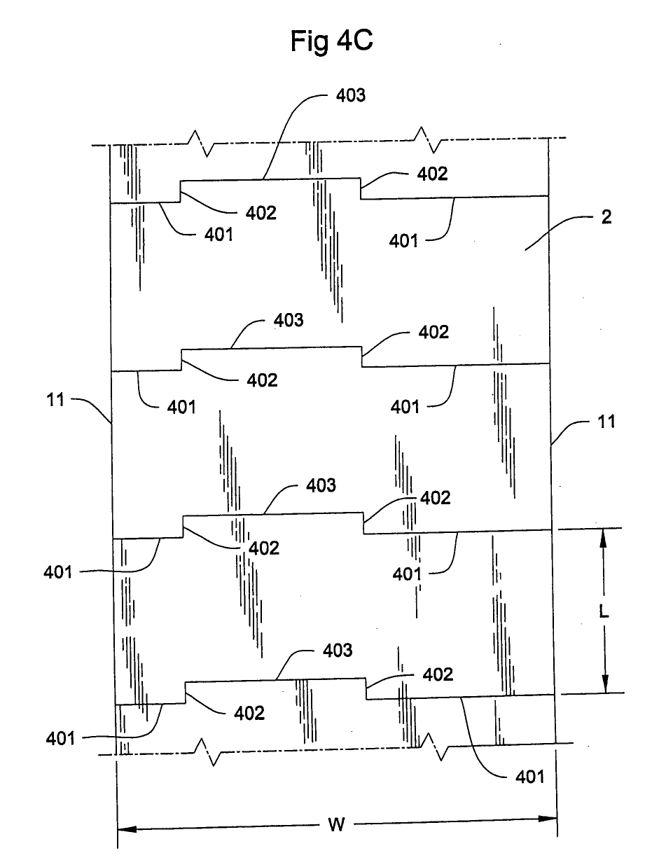

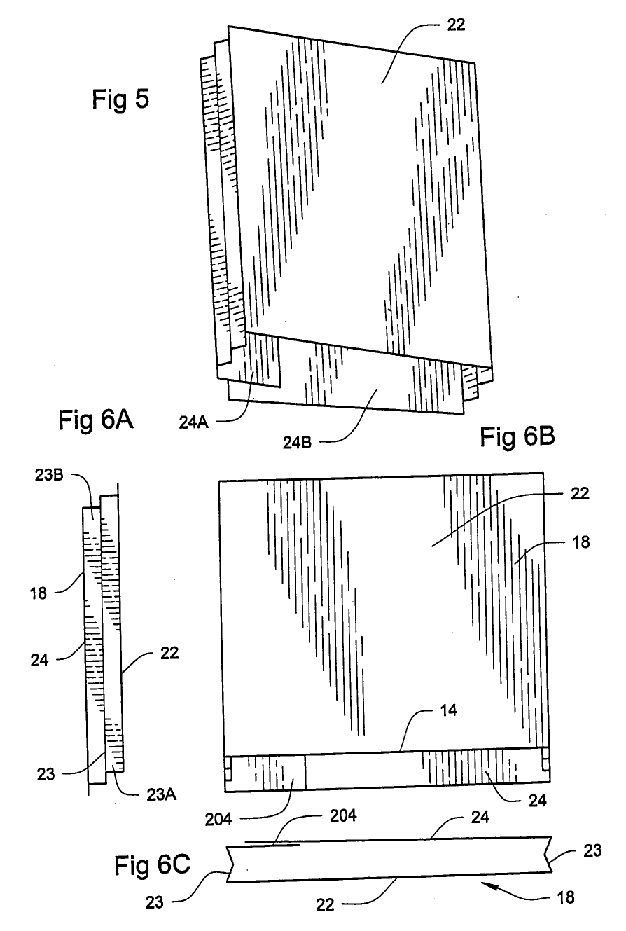

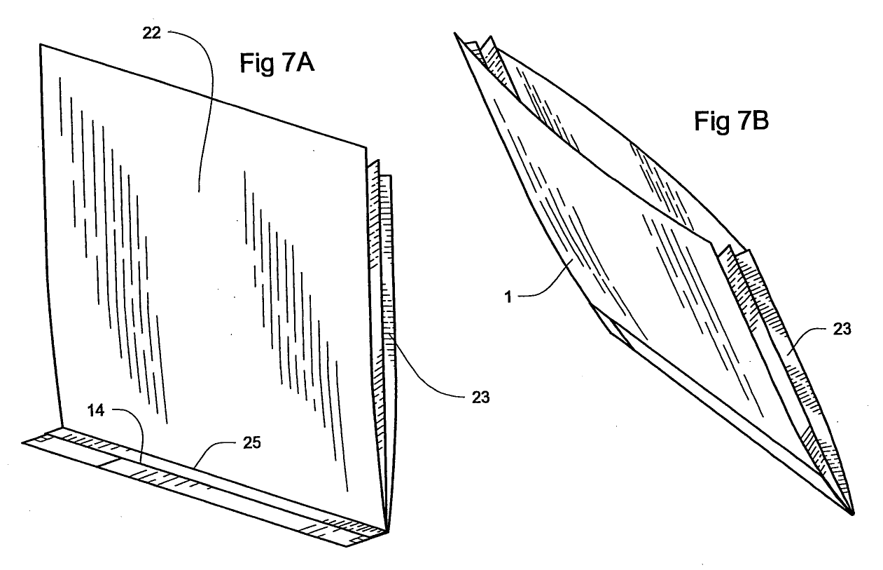

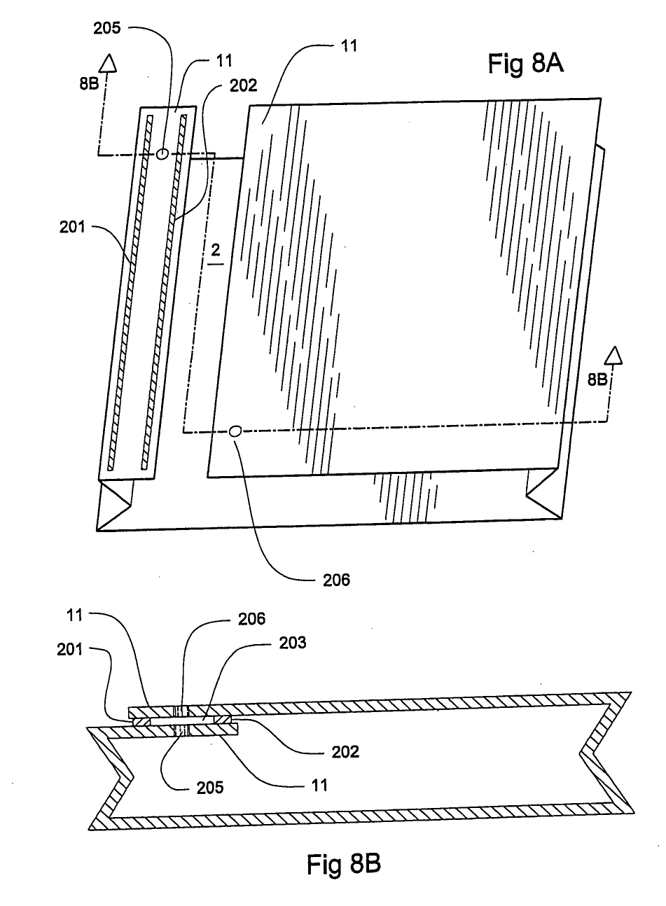

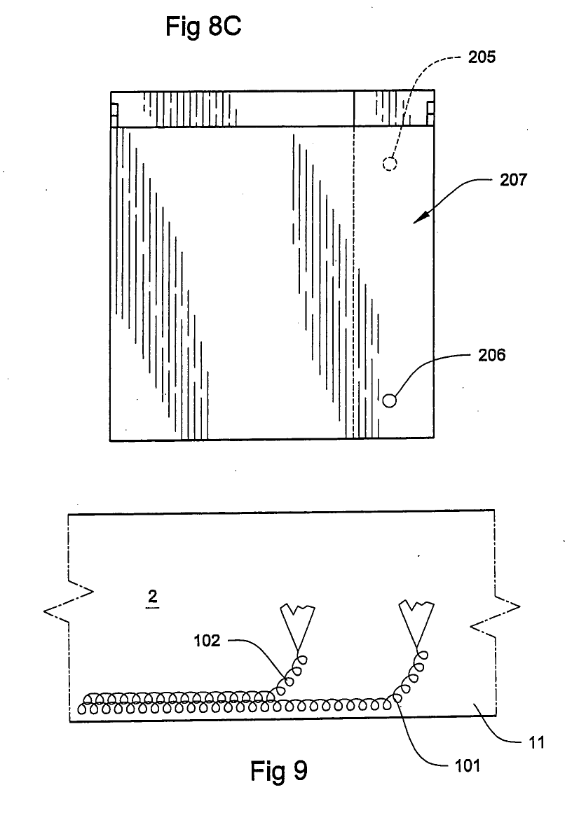

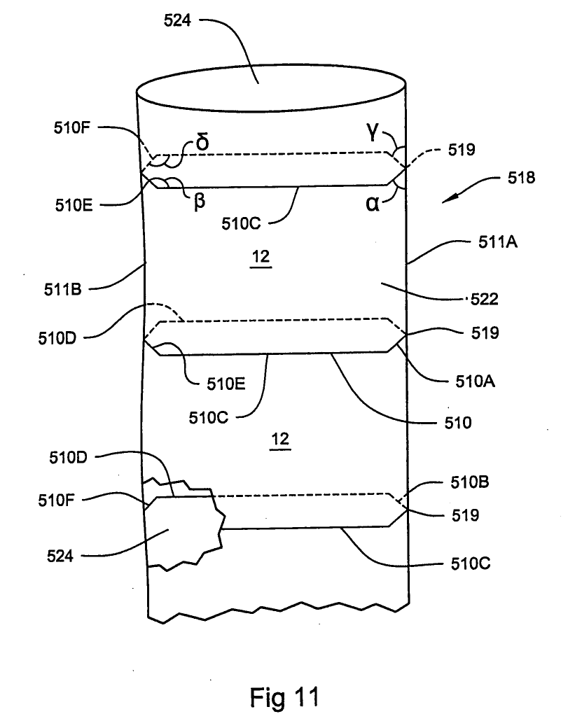

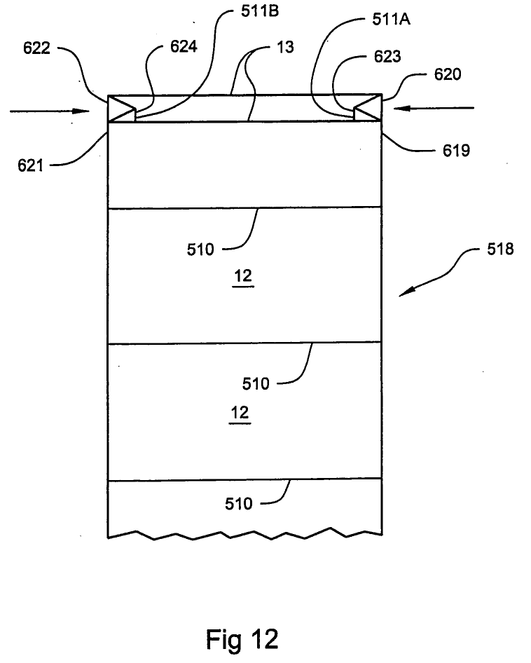

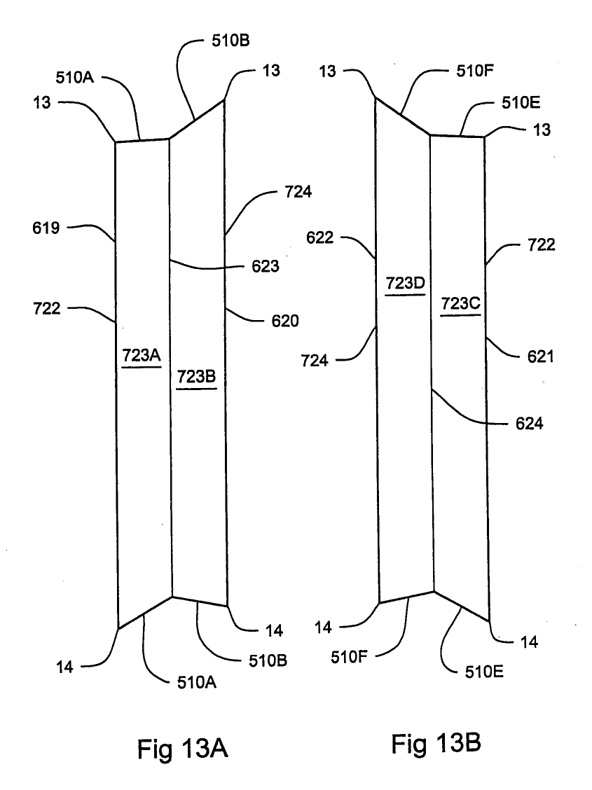

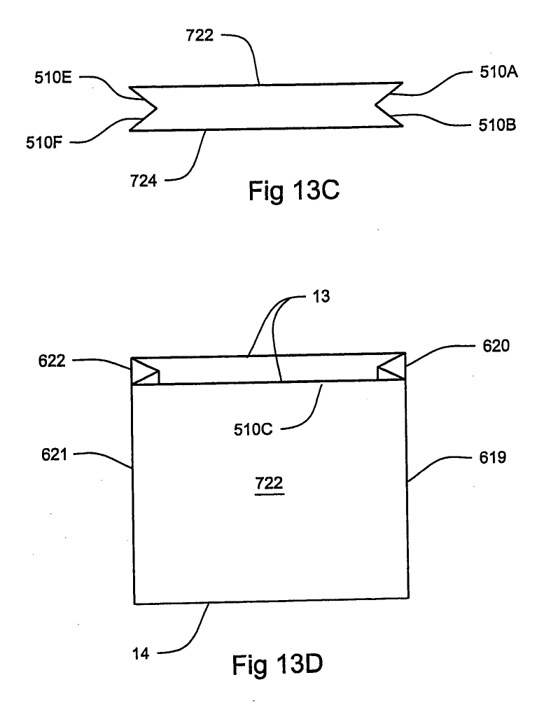

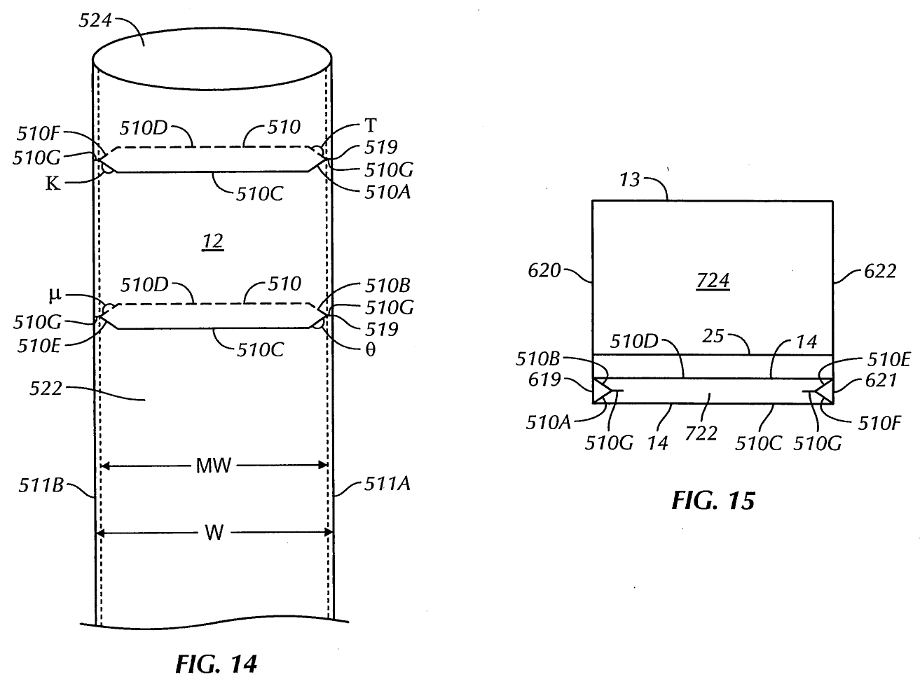

### DETAILED DESCRIPTION OF THE PREFERRED EMBODIMENT

The invention relates to a method of making a bag 1. In the preferred embodiment, bag 1 will be formed from a sheet 2. Sheet 2 will preferably be comprised primarily of polypropylene. Most preferably, sheet 2 will have multiple layers that are laminated together.

In one preferred embodiment, one of the layers is matrix 3. Matrix 3 may be a scrim or a net or any other conventional webbing pattern or combinations thereof. However, in the most preferred embodiment, matrix 3 is a weave 4.

In the preferred embodiment of weave 4, matrix 3 is comprised of a first layer of polypropylene fibers 5 positioned generally parallel to each other. A second layer of generally parallel polypropylene fibers 6 is also provided. Second layer of polypropylene fibers 6 is positioned at an angle to first layer 5, and preferably at a right angle; however, which fiber is on top and which is on bottom will alternate at each intersection of fibers. That is, fibers 5 and 6 are woven together. The individual fibers are not physically connected to each other at the intersections.

In the preferred embodiment the polypropylene weave 4 that comprises matrix 3 has a mass of between about fifty grams per square meter (about 580 denier) and about one hundred twenty grams per square meter (about 1350 denier), and preferably about sixty-two grams per square meter (about 900 denier). In this embodiment, the polypropylene fibers are axially oriented via pre-stretching. When polypropylene is extruded, the molecules in the fibers are typically randomly oriented. In this configuration, polypropylene is relatively weak, such that a sudden impact applied parallel to the length of the fiber could easily break the fiber. However, if a force is slowly applied to the fiber, the polypropylene molecules will become aligned in the direction of the force. Such fibers are said to be axially aligned, with the alignment typically being parallel to the length of the fibers. Axially aligned polypropylene fibers are much stronger than non-aligned fibers of the same weight. Suitable axially aligned polypropylene weave may be obtained from Ciplas, S. A. of Bogata, Colombia.

In one preferred embodiment, matrix 3 is laminated to a solid layer 7 of polypropylene. Solid layer 7 is preferably a seventy gauge (0.7 mil) biaxially oriented polypropylene sheet. Biaxial orientation means that the polypropylene molecules are oriented along two axes. When laminated together, the axes of orientation of solid layer 7 will preferably run parallel to the length and width of sheet 2 while the axes of orientation of the fibers of matrix 3 will also run parallel to the length and width of sheet 2. Thus, solid layer 7 and matrix 3 reinforce each other and give a great deal of strength to sheet 2. Solid layer 7 will also close the inter-fiber apertures of matrix 3, which will prevent water, powders, and most oils and vapors from passing through sheet 2. Solid layer 7 is preferably clear and will lend itself to printing techniques that are common in consumer packaged goods. Suitable biaxially oriented polypropylene sheets may be obtained from Vifan, Inc. of Morristown, Tenn.

Solid layer 7 is preferably laminated to matrix 3. The preferred laminate is transparent and preferably comprises a polypropylene base. Additionally, it will preferably contain between about fifteen to thirty percent polyethylene. Any printing will typically occur on solid layer 7.

Printing will occur on either the interior surface or the exterior surface of solid layer 7. When printing occurs on the interior surface of solid layer 7, a reverse printing technique will typically be used, and the ink will be applied to the side of solid layer 7 that faces matrix 3. In such cases, the ink can interfere with the adhesion of solid layer 7 to matrix 3. Thus, when printing on the interior surface of solid layer 7, the inventor contemplates adding a tackifier to the laminate to help solid layer 7 fully adhere to matrix 3. When a tackifier is used, it will preferably comprise about fifteen percent of the laminate by weight.

In addition to the tackifier, it is preferable to treat the portions of solid layer 7 to which ink has been applied with a liquid primer. The primer will help ionize the ink which help form a bond between the ink and the polypropylene layers. The preferred primer is Mica A31X™, available from the Mica Corporation of Shelton, Conn. The inventor contemplates applying about 0.2 lbs of Mica A31X™ per ream of solid layer 7 to the surface of solid layer 7. The primer will preferably only be applied where ink has been applied to sheet 7. Thus, if a portion of sheet 7 contains no printing, preferably no primer would be applied to that portion of sheet 7. The primer is preferably applied after the ink.

When printing is done on the exterior of solid layer 7, there is no need for a tackifier or primer. However, in the preferred embodiment, the inventor contemplates applying a coat of clear lacquer over external printing. This will seal the ink, provide an increased gloss on the finished bag, and increase the coefficient of friction of the surface of the bag. Increasing the coefficient of friction is especially advantageous in that it can provide the finished filled bags with a higher angle of slide—essentially, allowing the bags to be stored, displayed, and transported at a greater angle without sliding off stacks, shelves and the like.

Regardless of whether the printing is to be performed on the interior or the exterior of solid layer 7, heat resistant ink is preferably used. Suitable inks are available from the Sun Chemical Corp. of Parsippany, N.J., and from the Flint Group, N.A. of Plymouth, Mich.

In the preferred embodiment, a continuous layer of laminate 8 is applied to solid layer 7 at a rate of about 15 grams to about 30 grams per square meter. Matrix 3 is then brought into contact with laminate 8 and solid layer 7 to form a preferred embodiment of sheet 2.

Solid layer 7 and matrix 3 will most preferably be provided in rolls. Suitable machinery to spool solid layer 7 and matrix 3 off of their respective rolls and into multilayer sheet 2 is available from the Davis Standard, Corp. of Somerville, N.J.; Windomeller & Hoelscher K G of Lengerich, Germany; or the Starlinger Corp. of Weissenbach, Austria. Equipment suitable for extruding a molten laminate 8 onto solid layer 7 may be obtained from the Davis Standard, Corp., Windomeller & Hoelscher or the Starlinger, Corp.

In the preferred embodiment, laminate 8 is extruded at about 510° F. and will hit the solid layer 7 at about 400° F. Solid layer 7 and matrix 3 are brought into contact with each other immediately after the extrusion of laminate 8 and chilled with a water chiller to 68° F. Immediate chilling will prevent the high temperatures from degrading the polypropylene. Suitable chillers are available from the Davis Standard, Corp. and Windomeller & Hoelscher.

Although the preferred embodiment of sheet 2 has been described as consisting of three layers, it will be appreciated that fewer or greater numbers of layers of varying densities and strengths may be provided according to nature of product being packaged and the conditions to which it will be subjected.

Once sheet 2 is formed, it will be cut into detachable bag sections 9. In one preferred embodiment, bag sections 9 will form gusseted pinch bags. This is preferably performed by forming a plurality of staggered perforated lines 10 extending across sheet 2. Perforated lines 10 will preferably be comprised of several staggered sections.

Beginning at outer edges 11 of multi-layer sheet 2, a first section 10A is cut on both sides of sheet 2. Sections 10A are preferably cut substantially perpendicular to edges 11.

At the ends of sections 10A distal from edges 11, a second section 10B is cut on both sides of sheet 2. Sections 10B are preferably cut substantially parallel to outer edge 11.

Beginning at the ends of sections 10B distal from their respective sections 10A, a third section 10C is cut on both sides of sheet 2. Sections 10C are preferably cut substantially perpendicular to sides 11.

At the ends of sections 10C distal from sections 10B, a fourth section 10D is preferably cut on both sides of sheet 2. Sections 10D are preferably cut substantially parallel to edges 11.

At the ends of sections 10D distal from sections 10C, a fifth section 10E is preferably cut on both sides of sheet 2. Sections 10E are preferably cut substantially perpendicular to edges 11. At the ends of sections 10E distal from sections 10D, a sixth section 10F is preferably cut on both sides of sheet 2. Sections 10F are preferably cut substantially parallel to edges 11.

At the ends of sections 10F distal from their respective sections 10E, a seventh section 10G is cut. Section 10G is preferably cut substantially perpendicular to edges 11. Section 10G will preferably connect opposite sections 10F.

From the foregoing, it will be appreciated that perforated line 10 will extend across sheet 2 and will contain seven horizontal (perpendicular to edges 11) sections and six vertical (parallel to edges 11) sections. Horizontal sections 10G should be approximately the same length as or slightly shorter than the combined length of horizontal sections 10A. Horizontal sections 10C and 10E will be approximately the same length. Vertical sections 10B, 10D, and 10E can vary in length depending on how much stagger is desired in finished bag 1. However, each pair of vertical sections 10B will preferably be the same length. Likewise, with pairs of vertical sections 10D and 10F.

As noted above, a plurality of perforated lines 10 will be formed across sheet 2. Each pair of perforated lines 10 will delineate detachable bag sections 12, with one line 10 forming the upper edge 13 of bag section 12 and the other line 10 forming the lower edge 14 of bag section 12. However, in the preferred embodiment cutting perforated lines 10 will not separate sheet 2. Rather, sheet 2 will only have been perforated. It will still be possible to handle sheet 2 as a unit. However, perforated lines 10 will make it possible to separate bag sections 12 from sheet 2 by applying a lateral force to sections 12, when desired.

Perforated lines 10 are preferably formed using a laser perforator module 15. Laser perforator module 15 will preferably consist of a laser source 15A which will preferably be a carbon-dioxide laser of which the laser energy output can be continuous in nature (CW), or preferably can be modulated, resulting in discrete bursts or pulses of energy. The bursts or pulses of laser energy will be focused and directed by a focus/steering module 15B. The focus/steering module 15B will preferably be galvanometer-based and can be a pre-objective or post-objective scanning system used to create a two-dimensional focal plane 15C (or field-of-view) at the surface of sheet 2. The pulsed laser energy 15D will be focused by and directed by the focus/steering module 15B to anywhere within the focal plane, to a spot 15E small enough to result in an energy density sufficient to create a small hole or perforation 16 in sheet 2.

The output energy of laser source 15A shall be modulated in coordination with focus/steering module 15B and the motion of sheet 2 to create a perforated line 10 across the width W of sheet 2 while sheet 2 is in a motion parallel to its length L. Multiple laser perforator modules 15 may be positioned across the width W of sheet 2 and used simultaneously to improve processing efficiency.

In the preferred embodiment, each pulse from the laser source 15A will create a small circular perforation 16 in sheet 2. Each perforation 16 is preferably about 0.2 millimeters in diameter. Perforations 16 are preferably spaced on approximately 0.4 millimeter centers—i.e., the center of one perforation 16 is about 0.4 millimeters from the center of each adjacent perforation 16. As will be appreciated, the narrowest distance between each perforation 16 will be about 0.2 millimeters.

Using laser perforator module 15 to form perforations 16 provides at least one advantage over using mechanical cutters to form similarly sized and spaced perforations. Laser perforator module 15 essentially burns or melts each perforation 16 through sheet 2. However, in addition to creating these perforations 16, the laser will also heat a small area 301 immediately surrounding each perforation 16. Heating axially oriented polypropylene to near its melting point will cause the oriented molecules to become randomized, substantially weakening the polypropylene. Thus, by using laser perforator module 15 to form perforation line 10, the material in the preferred perforation line 10 remaining after line 10 has been cut will be a series of polypropylene strips 17 about 0.2 millimeters wide separated by 0.2 millimeter wide holes. However, rather than being axially oriented polypropylene, as would be the case if perforations 16 were formed mechanically, strips 17 will be comprised substantially, if not exclusively, of randomly oriented polypropylene molecules. This will make perforation line 10 much weaker than would be the case if perforation line 10 were formed by simply mechanically cutting the same series of holes in sheet 2.

Suitable laser perforator modules 15 are available from Preco, Inc. of Lenexa, Kans.

Although the principal manner of forming perforation line 10 described herein involves laser perforation, the inventors do contemplate mechanical formation of perforation line 10. In this alternate embodiment, sheet 2 would be scored along a line having the same pattern described above with respect to lines 10. A die cutter would be used in this embodiment. In the matrix/laminate/solid layer embodiment of sheet 2, the die would cut sheet 2 from the matrix 3 side. The die would completely sever matrix 3 across the entire length of line 10. However, the die would alternate between completely severing solid layer 7 and leaving strips of solid layer 7 either completely uncut or only scored. Suitable die cutters are believed to be available from Madern USA, Inc. of Apex, N.C.

However perforated line 10 is formed, it should preferably break cleanly and completely upon the application of about eight to about nineteen pounds of force per inch of width W of sheet 2, applied substantially linearly in a direction substantially parallel to the length L of sheet 2. To facilitate this, it may be preferable to completely sever the portions of perforated line 10 corresponding to vertical sections 10B, 10D, and 10F as well as the corners that transition between the vertical sections and the horizontal sections of line 10. These corners will preferably be cut on a radius of ⅛^{th} to 1/32^{nd} and preferably 1/16^{th} of an inch, rather than ninety degree angles, to facilitate separation.

After perforated lines 10 are formed, a gusseted tube 18 will preferably be formed from sheet 2. Sheet 2 will be folded along fold lines 19 that extend from upper edge 13 to lower edge 14 along lines that include vertical sections 10F. Sheet 2 will also be folded along fold lines 20 that extend from upper edge 13 to lower edge 14 along lines that include vertical sections 10D. Finally, sheet 2 will be folded along fold lines 21 that extend from upper edge 13 to lower edge 14 along lines that include vertical sections 10B. Equipment suitable for folding sheet 2 is available from Windomeller & Hoelscher or the Strong-Robinette Machine Corporation of Bristol, Tenn.

The folds made along fold lines 19 will preferably be made in a direction that will fold the interior surface of sheet 2 toward the interior surface of sheet 2 in the region of sheet 2 proximate fold line 19. The folds made along fold lines 20 will preferably be made in a direction that will fold the exterior of sheet 2 toward the exterior of sheet 2 in the region of sheet 2 proximate to fold line 20. The folds made along fold lines 21 will preferably be made in a direction that will fold the interior surface of sheet 2 toward the interior surface of sheet 2 in the region of sheet 2 proximate to fold lines 21.

Folding sheet 2 in the foregoing fashion will create a front face section 22 between sections 10G of upper and lower edges 13, 14 and between fold lines 19. It will also create first sidewall sections 23A between sections 10E of upper and lower edges 13, 14 and between fold lines 19 and 20. Second sidewall sections 23B will be formed between sections 10C of upper and lower edges 13, 14 and between fold lines 20 and 21. Folding sheet 2 in this manner will also create first and second rear face sections 24A and 24B between sections 10A of upper and lower edges 13, 14 and between fold lines 21 and edges 11. In all of the foregoing sections, the vertical dimension will be that dimension that is perpendicular to both upper and lower edges 13, 14.

When sheet 12 is folded in the foregoing fashion, rear face sections 24A and 24B will be substantially parallel to front face section 22 and will be positioned so that edges 11 meet. Gusseted tube 18 is formed when edges 11 are joined.

The foregoing explanation describes the formation of a gusseted bag. However, a flat pinch bag could be formed in substantially the same fashion. In this embodiment, staggered perforated lines 10 will be cut in a simple pinch pattern.

In this embodiment, beginning at outer edges 11 of multi-layer sheet 2, a first section 401 is cut on both sides of sheet 2. Sections 401 are preferably cut substantially perpendicular to edges 11.

At the ends of sections 401 distal from edges 11, a second section 402 is cut on both sides of sheet 2. Sections 402 are preferably cut substantially parallel to outer edge 11.

At the ends of sections 402 distal from their respective sections 401, a third section 403 is cut. Section 403 is preferably cut substantially perpendicular to edges 11. Section 403 will preferably connect opposite sections 402.

After perforated lines 10 are formed, a tube 18 will preferably be formed from sheet 2. Sheet 2 will be folded along fold lines 404 that extend from upper edge 13 to lower edge 14 along lines that include sections 402. Equipment suitable for folding sheet 2 is available from Windomeller & Hoelscher or the Strong-Robinette Machine Corporation of Bristol, Tenn.

The inventors contemplate joining edges 11 by applying adhesive to the exterior surface of 24A and the facing, interior surface of 24B. In all of the foregoing conditions, the inventor contemplates using a polypropylene base hot melt adhesive, preferably hot melt number 2903 available from the H. B. Fuller Co. of St. Paul, Minn.

Most relevant polypropylenes melt at around 335° F. and they begin to deteriorate substantially between around 325° F. and 335° F. However, hot melt should contact sheet 2 at a temperature high enough to soften the polypropylene and make it more susceptible to bonding but not so high that the adhesive substantially weakens the polypropylene in the vicinity of the seam that is being formed. Ideally, the hot melt will contact the surface of sheet 2 at about 285° F. to 300° F. and most preferably at about 290° F.

It will be appreciated that applying the adhesive to one edge 11 and then pressing the second edge 11 onto the adhesive that is resting on the first edge 11 will result in the adhesive contacting the second edge 11 at a cooler temperature than the adhesive had when it was initially applied to the first edge 11. This can result in a less than ideal bond to the second edge 11. This problem may be addressed by minimizing the time between when the adhesive is applied to the first edge 11 and when the second edge 11 is pressed into contact with the adhesive. Although delays between when the adhesive is applied and when the second edge 11 is brought into contact with the adhesive should be minimized in any event, the inventor has found that applying a double layer of hot melt to the first edge 11 achieves the best results.

In the preferred embodiment, the adhesive is applied to first edge 11 in a first continuous swirl pattern 101. Adhesive in a second continuous swirl pattern 102 is laid down immediately on top of first swirl pattern 101. Each swirl will preferably have a diameter of about ¼ to ¾ of an inch and most preferably ½ of an inch. First swirl pattern 101 is believed to help insulate second swirl pattern 102 by separating second swirl pattern 102 from first edge 11. Immediately after second swirl pattern 102 is applied, second edge 11 is brought into contact with first edge 11 and the double layer of adhesive that has been deposited on first edge 11. This will result in second swirl pattern 102 contacting second edge 11 at substantially the same temperature that first swirl pattern 101 contacted first edge 11. The bonds with each edge 11 will thus be substantially identical.

To achieve the preferred double swirl patterns 101, 102 adhesive is applied using a dual headed nozzle, such as die no. 1054730 (orifice diameter 0.018 inches) available from the Nordson Corporation of Westlake, Ohio. In the preferred embodiment, the nozzles are positioned about eight inches apart. Each nozzle is preferably positioned about 1 inch to about 4 inches above first edge 11 of sheet 2 and most preferably about 1.5 inches above first edge 11. The adhesive is preferably heated to about 325+ F. when it leaves the nozzles. The nozzles extrude strands of adhesive having a diameter of about 0.018 inches. The adhesive preferably leaves the nozzles at between about 80 psi and about 460 psi, depending upon the speed at which sheet 2 is moving. The swirl patterns 101, 102 are created with air heated to at least 325° F. and applied within the nozzle between about five and about twenty-four pounds per square inch (psi). All of the foregoing results in the adhesive reaching sheet 2 at the preferred temperature of 290° F. The inventor has found that applying adhesive in the foregoing fashion results in seams that meet both the heat test and freeze test, discussed above.

In another sealing option, edges 11 are configured to overlap about one inch. Two double layer swirl lines of adhesive 201, 202 are laid down on first edge 11, each swirl line 201, 202 being formed in substantially the same fashion described above. Swirl lines 201, 202 will be substantially parallel and separated by about ½ inch. When second edge 11 is brought into contact with swirl lines 201, 202, this will create a channel 203 in seam 204 wherein edges 11 will be joined at swirl lines 201, 202, but not in the approximate ½ inch between swirl lines 201, 202. During the cutting stage, a first hole 205 will have been formed in first edge 11 proximate either upper edge 13 or lower edge 14 of bag 1, preferably using a die cutter such as model no. CPS-6100 available from the Park Air Corporation of Brockton, Mass. Hole 205 will preferably be about 1/16^{th} to about 5/16^{th} of an inch in diameter and will preferably be positioned between swirl lines 201, 202. Hole 205 will thus provide fluid communication between the interior of bag 1 and channel 203. A second hole 206 is also provided in second edge 11 during the cutting stage, preferably with laser perforation module 15. Second hole 206 is also preferably about 1/16^{th} to about 5/16^{th} of an inch in diameter and is positioned between swirl lines 201, 202. Thus, second hole 206 will provide fluid communication between the exterior of bag 1 and channel 203. Like first hole 205, second hole 206 is also positioned proximate to either upper edge 13 or lower edge 14 of bag 1; however, second hole 206 should preferably be positioned at substantially the opposite end of bag 1 from first hole 205. While holes 205, 206 are preferably positioned close to edges 13, 14, they should not be positioned so close that closing bag 1 closes either hole 205 or 206.

When formed in the foregoing fashion, holes 205, 206 and channel 203 form a vent 207 in bag 1. This configuration will make it difficult for water to enter bag 1 via vent 207. The longer the space in channel 203 between holes 205, 206, the more difficult it will be for water vapor to enter bag 1 via vent 207. The same holds true for insects. However, gases within bag 1 can easily escape bag 1 anytime there is positive pressure inside bag 1. Positive pressure within bag 1 can commonly occur in at least two situations. First, certain products naturally evolve gases. High fat content dog foods are an example of such a product. Vent 207 would allow these gases to escape, avoiding the bloated appearance they can create in bags 1. Allowing these gases to escape gradually can also avoid odor problems associated with their accumulation. Gases, namely air, can also be introduced into bag 1 during filling. As bags 1 are stacked, the pressure applied to bags 1 by the stack will force air out via vent 207. This has two principle positive effects. First, it facilitates stacking, by allowing bags 1 to lie flatter, and second, it helps prevent the contents of bag 1 from becoming stale by limiting the exposure of those contents to air.

Beside the hot melt adhesive described above, other sealing options for seam 204 include thermal welding and radio frequency welding. Suitable thermal welding equipment may be obtained from the Miller Weldmaster Corporation of Navarre, Ohio. Another sealing mechanism would be extruded polypropylene. This would preferably be applied using a bead extruder, in which the molten polypropylene would be deposited onto first edge 11 in a bead.

Once edges 11 are joined together, rear face sections 24A and 24B will form a rear face section 24. Gusseted sidewalls 23 will also be formed by sidewall sections 23A and 23B, the gusseted version of bag 1. Sidewalls 23 will connect front face section 22 to rear face section 24.

It will be appreciated that staggering lines 10 in the manner described above will cause lower edge 14 of front face 22 to be vertically displaced from lower edge 14 of rear face 24. Similarly, staggering lines 10 will also cause each lower edge 14 of sidewall sections 23A and 23B to be vertically offset relative to each other and with respect to lower edges 14 of front and rear faces 22, 24. It will also cause lower edge 14 of sidewall sections 23A, 23B to be vertically positioned between lower edge 14 of front face 22 and lower edge 14 of rear face 24.

Once tubes 18 are formed, they will be separated from sheet 2. As discussed above, this is preferably done by applying a lateral force to the terminal tube 18 strong enough to break perforated line 10 that forms upper edge 13 of the terminal tube 18. Equipment suitable for detaching each tube 18 is available from Windomeller & Hoelscher K G or the Strong-Robinette Machine Corporation.

Bag 1 may be formed from gusseted tube 18 by closing one end of gusseted tube 18. This is preferably accomplished by applying a polypropylene based hot melt adhesive, such as H. B. Fuller's hot melt number 2903, to the interior surface of rear face 24 at a point below lower edge 14 of front face 22. Tube 18 would then be folded along a line 25 generally parallel and proximate to lower edge 14 of front face 22. This will place a portion of the exterior of front face 22 into contact with itself. It will also place a portion of the interior of rear face 24 into contact with front face 22. Additionally, it will place a portion of the interior and exterior surfaces of sidewalls 23 into contact with front face 22. The adhesive will secure all of the foregoing together, securely closing one end of tube 18 and forming bag 1. It should be noted that this closure method results in seams that are substantially impermeable to water, insects, and most oils. Bags that close in the foregoing manner are sometimes known as “pinch bags.” Equipment suitable for sealing one end of tube 18 is available from Windomeller & Hoelscher K G or the Strong-Robinette Machine Corporation.

Alternatively, either end of bag 1 may be closed by folding it in the same or substantially the same manner described above and sealing the end together using thermal welding equipment available from the Miller Weldmaster Corporation of Navarre, Ohio.

Once bag 1 has been formed, it may be filled with whatever bag 1 is intended to hold and the other end sealed in substantially the same fashion as described above with respect to the first end.

The finished bag 1 will be resistant to punctures and tears by virtue of the high strength polypropylene that comprises bag 1. This will protect bag 1 from damage during shipping and while stored in a retail environment. The polypropylene will also minimize spillage and/or leakage from bag 1, reducing the potential for slip and fall injuries. The polypropylene will also protect the exterior of bag 1 from discoloration caused by the contents of bag 1. Similarly, the polypropylene will protect the contents of bag 1 from deterioration due to elements in the environment.

Although the discussion of the invention has focused on polypropylene bag material, the present invention is not limited to bags 1 made exclusively from polypropylene. Rather, bags 1 may contain non-polypropylene elements, such as laminates, inks, adhesives and even plastic combinations that comprise polypropylene blended or interwoven with non-polypropylene minority components, and still be considered a polypropylene bag or sheet.

These and other modifications for the manufacture of bag 1 will be apparent to those of skill in the art from the foregoing disclosure and drawings and are intended to be encompassed by the scope and spirit of the following claims.

1. A method of forming a tube for forming a pinch bag from a polypropylene sheet having a width, a length and edges comprising;
a. perforating said polypropylene sheet along a pre-selected line;
b. folding said polypropylene sheet so that said edges overlap;
c. adhering said edges together; and
d. applying a force to a terminal section of said polypropylene sheet sufficient to break said perforation and thereby separate said terminal section from said polypropylene sheet.

2. A method of forming a tube for forming a pinch bag from a polypropylene sheet according to claim 1 wherein said polypropylene sheet is formed by laminating a polypropylene matrix to a solid layer of polypropylene.

3. A method of forming a tube for forming a pinch bag from a polypropylene sheet according to claim 2 wherein said matrix comprises a weave.

4. A method of forming a tube for forming a pinch bag from a polypropylene sheet according to claim 3 wherein said weave comprises axially oriented polypropylene strands.

5. A method of forming a tube for forming a pinch bag from a polypropylene sheet according to claim 4 wherein said solid layer comprises biaxially oriented polypropylene.

6. A method of forming a tube for forming a pinch bag from a polypropylene sheet according to claim 1 wherein said sheet is sufficiently perforated to allow said perforation to be broken upon the application of between about eight to about eighteen pounds of force per inch of width of said polypropylene sheet.

7. A method of forming a tube for forming a pinch bag from a polypropylene sheet according to claim 6 wherein said polypropylene sheet comprises axially oriented polypropylene fibers.

8. A method of forming a tube for forming a pinch bag from a polypropylene sheet according to claim 7 wherein said perforation is performed with a laser.

9. A method of forming a tube for forming a pinch bag from a polypropylene sheet according to claim 8 wherein said laser forms a series of closely spaced perforations along said pre-selected line.

10. A method of forming a tube for forming a pinch bag from a polypropylene sheet according to claim 9 wherein said laser heats an area of said polypropylene sheet surrounding said each said perforation sufficiently to cause said axially oriented polypropylene fibers in said area to become substantially randomly oriented.

11. A method of forming a tube for forming a pinch bag from a polypropylene sheet according to claim 10 wherein said perforations are spaced sufficiently close so that substantially all of said pre-selected line comprises either perforation or substantially randomly oriented polypropylene.

12. A method of forming a tube for forming a pinch bag from a polypropylene sheet according to claim 11 wherein said polypropylene sheet further comprises biaxially oriented polypropylene.

13. A method of forming a tube for forming a pinch bag from a polypropylene sheet according to claim 12 wherein said axially oriented polypropylene fibers are provided in a matrix.

14. A method of forming a tube for forming a pinch bag from a polypropylene sheet according to claim 13 wherein said matrix is a weave.

15. A method of forming a tube for forming a pinch bag from a polypropylene sheet according to claim 1 wherein said polypropylene sheet consists essentially of polypropylene.

16. A method of forming a tube for forming a pinch bag from a polypropylene sheet according to claim 1 wherein adhesive is applied to said edges in parallel strips.

17. A method of forming a tube for forming a pinch bag from a polypropylene sheet according to claim 16 wherein said parallel strips are separated by at least about one half of an inch.

18. A method of forming a tube for forming a pinch bag from a polypropylene sheet according to claim 17 wherein said edges are positioned one on top of the other, thereby creating an upper edge and a lower edge.

19. A method of forming a tube for forming a pinch bag from a polypropylene sheet according to claim 18 wherein said upper edge contains a first perforation between said parallel strips and wherein said lower edge contains a second perforation between said parallel strips and wherein said first perforation and second perforation do not overlap.

20. A method of forming a tube for forming a pinch bag from a polypropylene sheet according to claim 18 wherein said first perforation and said second perforation are offset by at least about one foot.

21. A method of forming a tube for forming a pinch bag from a polypropylene sheet according to claim 1 wherein said edges are positioned one on top of the other, thereby creating an upper edge and a lower edge.

22. A method of forming a tube for forming a pinch bag from a polypropylene sheet according to claim 21 wherein adhesive is applied to said lower edge in at least a first layer and a second layer.

23. A method of forming a tube for forming a pinch bag from a polypropylene sheet according to claim 22 wherein each layer of adhesive is applied in a swirl pattern.

24. A method of forming a tube for forming a pinch bag from a polypropylene sheet according to claim 23 wherein said first layer of adhesive is applied directly to said lower edge and said second layer of adhesive is applied onto said first layer of adhesive.
